(19) United States
(12) Patent Application Publication
(10) Pub. No.: US 2004/0098451 A1
(43) Pub. Date: May 20, 2004

(54) Method and system for modifying web content for display in a life portal

(75) Inventor: Brian V. Mayo, Greenwood, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(73) Assignee: Humanizing Technologies, Inc.

(21) Appl. No.: 10/298,183

(22) Filed: Nov. 15, 2002

(51) Int. Cl. G06F 15/16

(52) U.S. Cl. 709/203

(57) ABSTRACT

A user-created life portal for viewing and accessing content on the Internet is described. The platform, referred to as a life portal, is configured by the user to display only content that is of interest to the user, thereby reflecting the personality and life of the user. The content displayed in a life portal is scraped from web sites and is not limited to sites licensed or maintained by the life portal service provider. Before content is displayed as a view in a portlet in a life page, the content is modified so that errors and unexpected behavior is minimized. This is done by parsing the content, for parsed views, and applying rules to the content thereby making the content suitable for display as a view. The rules are applied intelligently in that only rules appropriate for a domain are applied to pages from that domain. In this process, each web page retrieved is essentially customized by application of an appropriate and tested set of rules. If a domain is unknown to the service provider, a default set of rules are applied and new rules, if necessary, are added to a rule set to handle future processing of content from the previously unknown domain.

### BACKGROUND OF THE INVENTION

1. Field of the Invention

The present invention relates generally to Internet application software and web site configuration. More specifically, it relates to a personal portal web site and to methods for processing content for display in a life page component in a life portal.

2. Discussion of Related Art

There are presently numerous ways to create custom or personal homepages at high-traffic portals on the Internet as well as at lesser known web sites. For example, conventional personal portals designed from the “top down,” such as “My Yahoo” and “My Excite,” among many other similar user tools and options at other web sites and portals have been available for many years.

However, despite their availability for the last several years, the use of personal home pages at widely used portals has not seen widespread acceptance among a vast majority of Internet users. This is a result, in large degree, to the relative complexity and sophistication required to configure, program, and maintain personal and custom web pages. Moreover, even after overcoming the initial barrier to creating and configuring personal web pages, many users have found that the sites they have created are, indeed, not as personal or customized as they were expecting. Many of them continue having difficulty retrieving and displaying content that is truly targeted to their interests, preferences, and priorities. Thus, for many users, tools for creating personal web sites do not satisfactorily meet their expectations or needs. For example, although a user can create a personal homepage at a portal or portal-type web site, the user often still must pass through several web pages to reach content of interest to the user. In one scenario, a user wanting to check local high school sport scores or check scheduling information for community events may not be able to do so if going through present personal web sites, or a user may have to view multiple pages before reaching the page with the relevant content. As such, the level of customization of user home sites at many portals is not satisfactory.

Furthermore, the content (e.g., local news, sports, weather, specialized subjects, and so on) may not be retrievable from the portal or ISP hosting the user's personal web site. The range of content available may be limited to the content created or hosted by the portal or made available to the portal (e.g., licensed by the portal or ISP), or may otherwise be from a limited range of sources. Typically, the portals and ISPs providing the personalized portal service are content aggregators. However, the amount of content that can be aggregated is necessarily limited because most of the content on the Internet is not available for syndication and, therefore, cannot be collected by third-parties, such as portals. Consequently, content aggregators cannot offer the breadth of content needed to fully meet the content needs of all potential users, each of whom will likely have unique, wide-ranging interests. The sources available to the portal are limited to sources licensed for use by the portal and may not have the content the user wants, thereby restricting the level of customization of the personal web pages.

Furthermore, portals using present meta-browsing technology for providing content in personal portals have significant shortcomings with respect to displaying various types of content. Meta-browsing technology generally fails to address conflicts and errors that arise when manipulating various types of content and how web sites implement or handle content, such as HTML and Java script. This limits the portals ability to provide content relating to various aspects of a user's life. Furthermore, present meta-browsing technology fails to allow users to see the entire range of content from a web page. For example, present meta-browsers only allow users to see content limited to a single table and does not enable the user to see complete portions of a web page. Present technology also often fails to maintain and consistently display tables in views via present meta-browsers. Additionally, meta-browsing technology is not efficient at locating content that a user will likely want to follow in order to stay current on the user's interests. Finally, meta-browsing technology is often difficult and cumbersome to use, making it inaccessible to the majority of non-technical users.

Issues also arise when content, such as HTML and Java script, from a third-party web site is scrapped and re-displayed outside of its original context at another web site. When content, such as a table from a web page or a complete web page, is scrapped and re-displayed at another web site and viewed through a meta-browser, problems and breakdowns occur. For example, HTML code may reference Java script that is outside of the portion displayed which causes breakdowns and unexpected behavior from the HTML. Other issues such as pop-up windows, error messages, and other features may not function as expected or may be undesirable when displaying and viewing the scrapped web content on a third-party web site. Present meta-browsers fail to address these and similar issues that arise from displaying content from external web sites.

What is needed is a method and system for processing content from an external web site so that the content can be displayed without errors and breakdowns in functionality. These systems and methods should be able to accept content from sites not previously visited or not known to a service provider and, nevertheless modify the content so that there is a high probability that the content will be displayed without problems and, generally, function in a manner consistent with user expectations. This should also be done transparent to the user, that is, the user should not be required to intervene in the process of modifying and displaying the content.

### SUMMARY OF THE INVENTION

In one aspect of the present invention, a method of modifying content, such as HTML from a web page from an originating site for display in a life portal is described. An applet or portal engine determines whether a domain from which content is being retrieved is listed in a domain table. If the domain is listed in a domain table, a corresponding rule set is identified. This is done by examining a domain/rules mapping table which associates domains with rules. The rules are applied to content from the domain. In one embodiment, the content is HTML and the rules modifies the HTML and other code, such as javascript, such that displaying a portion of the HTML in a view, separated from it original context, does not cause problems or breakdowns. If a domain is not found in the domain table, a default set of rules is applied to the web page. If the default rules do not address all problems arising from displaying the view, new rules are added to a rule set maintained by a life portal service provider. The rule set is expected to grow as new domains are added to the domain table. The application of the rules ot content in this manner enables the display of HTML in views with minimum issues and breakdowns when a user sees the content in a view in a life page.

### BRIEF DESCRIPTION OF THE DRAWINGS

The invention will be better understood by reference to the following description taken in conjunction with the accompanying drawings in which:

FIG. 1 is a hierarchical diagram showing a structure of a life portal in accordance with one embodiment of the present invention.

FIG. 2 is diagram showing relationships among a life portal service provider, a life portal user, and third-party web sites providing content for the life portal.

FIG. 3 is an overview flow diagram of a process of creating a custom life portal from a standard life portal in accordance with one embodiment of the present invention.

FIG. 4 is a screen display of a life portal and life page showing a magazine and view in accordance with one embodiment of the present invention.

FIG. 5A and 5B are screen displays of a life portal showing a menu of actions a user can perform on views, magazines, and life page in accordance with one embodiment of the present invention.

FIG. 6 is a diagram showing a server-side implementation of the life portal in accordance with one embodiment of the present invention.

FIG. 7 is a diagram showing a client-side implementation of the life portal in accordance with one embodiment of the present invention.

FIG. 8 is a diagram showing a logical representation of sample data sets or tables that may be used to apply rules to content before the content is displayed in a life page in accordance with one embodiment of the present invention.

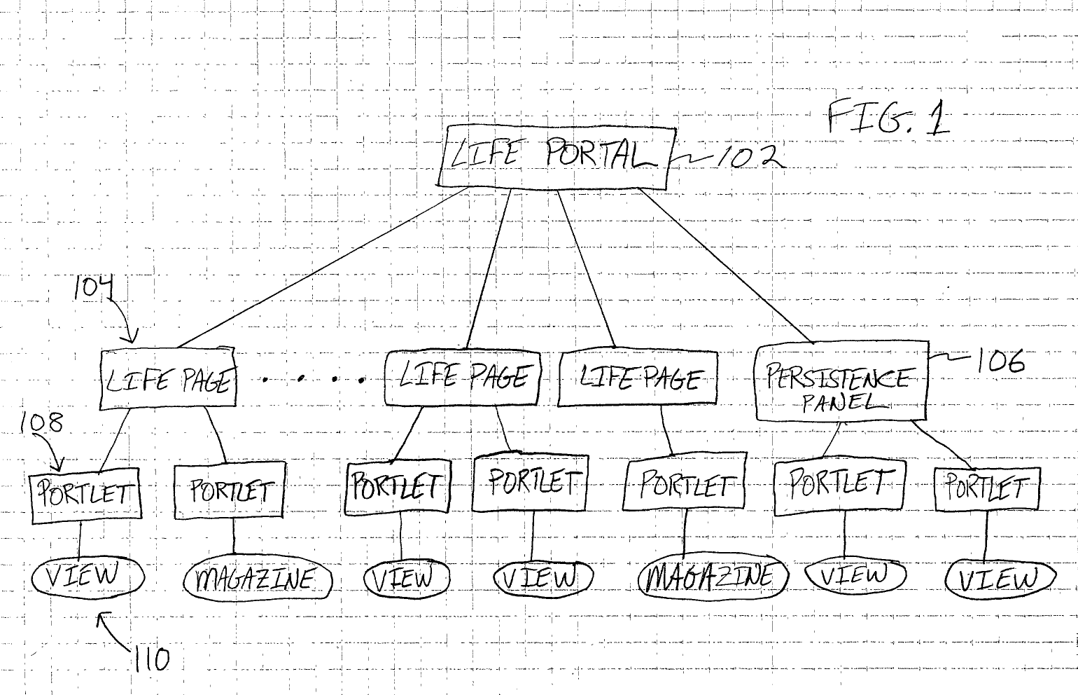

### DETAILED DESCRIPTION

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

The present invention encompasses a user-created portal on the Internet referred to herein as a life portal. A life portal contains one or more storage containers referred to as life pages. A life page is a content storage area which, in turn, holds information in the form of magazines and views, both of which are content specifically compiled for a user. Magazines and views are stored in portlets. Thus, a life page may have multiple portlets for storing content. The life portal of the present invention reflects the life of a user; it displays content of specific, user-defined interest to selected aspects of the user's life. A life portal reflects the wide ranging interests of a user limited only by the content accessible on the Internet and other public and private networks, such as Intranets, virtual private networks, and so on. In the described embodiment, the Internet and browsers are used for illustration, however, other networks, data sources, and user interfaces can be applied to the concepts and implementations described herein for the present invention.

Methods and systems of creating and using a life portal and the components comprising a life portal are described in the various figures. In a preferred embodiment of the present invention, a user is initially presented with a standard life portal. A standard life portal is customized by a user to display content, as views and magazines, most of which is retrieved from the Internet.

In another preferred embodiment, the user is presented with an empty life portal from where a user can begin creating life pages and a persistence panel, described below. The content is displayed as views and magazines which are stored in life pages classified by topics chosen by the user. In another preferred embodiment, the user is taken through a series of queries when initially creating a life portal. Based on replies to the queries, the new user is presented with pre-created life pages that contain views and magazines that may be of interest to the user. It also gives the user an opportunity to get familiar with using and manipulating life pages, views, and magazines. The replies to the queries determine which categories or topics are presented to the user in the form of life pages. For example, if the user's interest lie more in finance and business rather than entertainment or sports, the pre-created life pages selected will reflect these broad categories which the user can further customize. Of course, the user can, and likely will, create his own life pages, views, and magazines that uniquely reflect aspects of the user's life.

A hierarchy of components comprising a life portal is shown in FTG. 1A. At the root of the hierarchy is a life portal 102 on the Internet viewable through a browser. Below the life portal are one or more life pages 104. There may also be a persistence panel 106, a special type of container storing content that the user views often or would like to see at all times while in the life portal and, therefore, is not ideally suited for storing in a life page. A persistence panel contains views and/or magazines that are always displayed on a life portal. Below each life page are portlets 108. Contained in a portlet is content 110, at the bottom of the hierarchy, specifically, views and magazines. The views and magazines can be either pre-created or uniquely created by a user.

The life portal of the present invention has a user interface designed to enable a user to navigate through the portal and create and retrieve content in an efficient and intuitive manner. In a described embodiment, for example, a life page is represented by a tab icon, resembling a folder tab. In other preferred embodiments other graphical icons or designs, such as buttons or menu bars can be used.

A life portal engine and overall administration and operation of life portals are under control of a life portal service provider. As described in greater detail below, content from the Internet is scraped or fetched from a wide variety of web sites, theoretically any web site on the Internet accessible with a browser. In the described embodiment, the life portal service provider servers store text utilized for indexing magazine content. Techniques for scraping or collecting content from web sites are known to persons of ordinary skill in the field of Internet application programming. The service provider is not a conventional content aggregator that is limited or restricted to scraping content from only selected sites or sites having a relationship with the service provider; that is, content in a life portal is not restricted to so-called “walled gardens.”

A user modifies a life portal primarily by creating, deleting, and modifying life pages, views, and magazines. A user can change the criteria used by life portal application software to fetch content from the service provider's databases, thereby changing the views and magazines in the life pages and persistence panel.

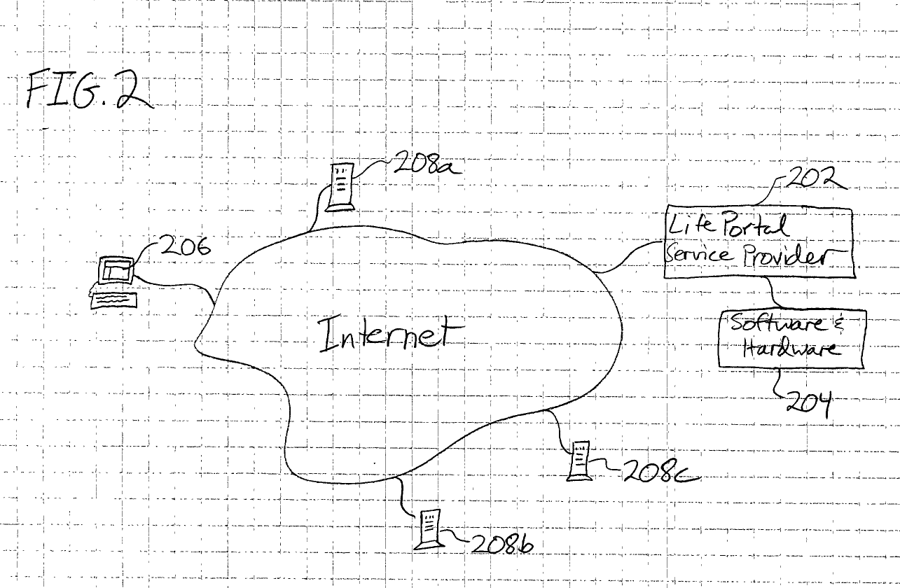

The relationships among the service provider, a life portal user, and web sites providing content on the Internet are shown in FIG. 2. A life portal service provider 202 maintains software and hardware components 204 that power the creation and upkeep of numerous life portals, such as a life portal 206. For example, one of the software components 204 is a database containing content, such as news articles and other types of text-based content, scraped from web sites and themed by the life portal service provider using techniques known in the field. As described in greater detail below, the themed content is used to create magazines. The range of web sites, such as sites 208a, 208b, and 208c, from which content is scraped is unlimited insofar that the service provider is permitted to access the site and retrieve content.

Content is retrieved from the third-party web sites and themed at the life portal service provider 204 for compiling magazines. After the content is themed, it is distributed to life portal 206. The service provider does not place any self-imposed restrictions on which sites it can access to scrape content. Thus, the service provider is not limited to content hosted, licensed, or created by the provider. Generally, the service provider will select which web sites are accessed. The user can request that the service provider access specific sites to scrape content that the user has a specific interest in. The service provider will consider the request and make a decision as to whether to access the sites. In another preferred embodiment, the service provider may place reasonable restrictions on which sites it will access, such as refusing to access to pornographic sites or sites that contain content not legally obtained by the sites, such as pirated material.

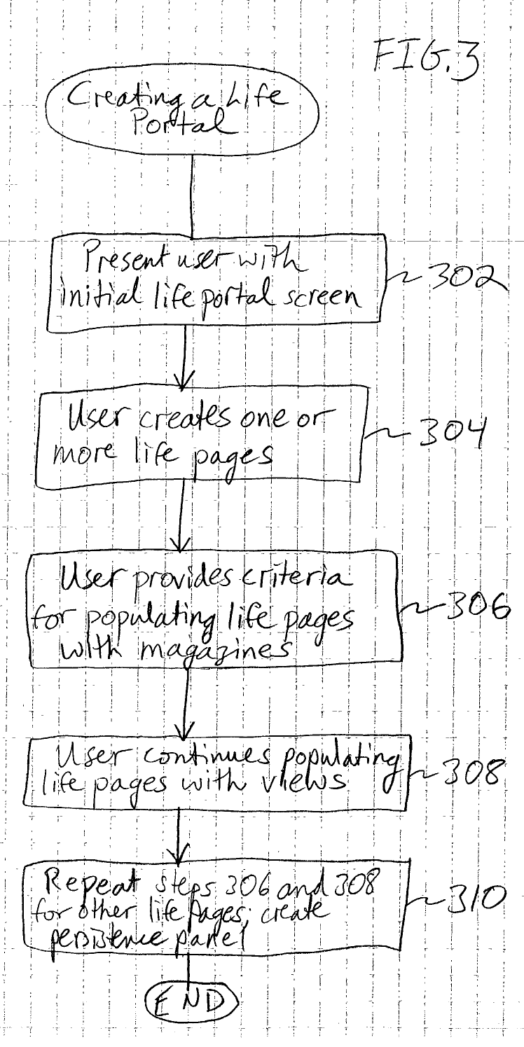

FIG. 3 is an overview flow diagram of a process of creating a personal life portal in accordance with one embodiment of the present invention. Before the process begins, a user goes to the life portal service provider web site on the Internet. In one scenario, the user's Internet service provider provides a link to the life portal service provider registration page. For example, the life portal may be a tool or feature offered by an ISP to its subscribers and is powered by the life portal service provider. In any case, once at the registration page, the user creates a password and completes other administrative steps as required by the ISP or life portal service provider.

At step 302 the user begins the process of creating a customized life portal. One of the primary goals of the present invention is to allow the user to create a portal that closely reflects various aspects of the user's life. Specifically, at step 302 the user is presented with a blank life portal screen. In other preferred embodiments, the user responds to queries which are examined by the life portal service provider so it may provide the user with pre-created life pages. In the described embodiment, the content in the pre-created life pages include sites that the service provider believes can provide high quality content or content that will likely be of interest to many of its users.

The present invention enables a user to build a life portal dynamically from the bottom-up; that is, the user builds a unique and customized life portal to match her interests and specific needs by retrieving content from the service provider database and that has been themed for inclusion in magazines and content from an unlimited range of web sites on the Internet for views. The user creates a truly unique portal that is closely tailored for her and reflects the various aspects of her life.

Content is scraped from a wide range of web sites by a portal engine and themed and clustered based on the subject matter of the content. The portal engine scrapes can scrape any web site accessible through a browser or any other type of user interface capable of accessing content on the Internet or public or private network. In the described embodiment, the portal engine scrapes web sites and places the scraped content in document roots or buckets. In other preferred embodiments, various types of data formats or data in other types of markup languages from data sources besides the Internet can be retrieved. The content scraped is from pages at the sites that have content on them at is updated regularly. Once a site is scraped initially, subsequent content scrapes are of articles and content that have been updated, for example, daily or weekly. Methods for scraping and retrieving content from web sites are known in the field of Internet application programming.

After the content has been retrieved, the life portal service provider scans the content and assigns themes to the content. For example, dominant phrases, words and so on are identified and the portal engine attaches one or more themes to the content. The key themes are extracted and stored with the content in a database. Thus, whenever content is pulled from the database, the content themes are pulled as well. This is done using algorithms known in the field of computer programming. After content is themed and before the content and the theme identifiers are stored in the database, the content is clustered with existing content based on the content's themes. Newly scraped content may have more than one theme in which case a link to the content resides in more than one location in the clustering hierarchy. New content is clustered with existing content using algorithms known in the field of computer programming. By clustering content themes, the portal engine can retrieve all content relevant to a particular topic. This process is used in compiling articles for magazines.

The life portal service provider can also create magazines for its users. A pre-created magazine is created in the same way as regular magazines except the service provider first identifies each magazine source or web site. For example, a pre-created magazine on professional basketball may have as sources NBA.com, the NBA page of the ESPN.com web site, and the NBA page of the FoxNews.com web site. These three sources, among others, are content sources that the service provider can use to create a magazine which it makes available to life portal users.

A user has the ability to create views of multiple lesser known sites which provide content that may not be available at many of the major portals and web sites, such as Excite, MSN, or Yahoo. A user can also create magazines containing content on any topic of interest to the user. Magazines contain links to textual content and associated pictures, such as news stories relevant to the topic chosen by the user, and that the service provider has themed. In the described embodiment, a user can also select content from pre-created views and magazines created by the life portal service provider. These pre-created views and magazines contain content that may be of interest to a wide range of users or may be high-quality content that the service provider believes would appeal to its users. In creating a magazine, the user launches a search of the content already scraped, themed, clustered, and indexed by the service provider. The user is not restricted to a so-called “walled garden,” a limited collection of web sites, when retrieving content. The user may also request that specific web sites be scraped for content.

At step 304 the user begins creating life pages. In one preferred embodiment, the user is presented with an empty life page that can be described as a canvass on which a user will configure and arrange content, namely, views and magazines. In another preferred embodiment, the initial life pages are created by selecting categories from a list of pre-defined categories supplied by the service provider or by responding to queries posed by the service provider to efficiently determine the user's interests. The user can assign essentially any name to the life pages. The names are displayed on tabs or other graphical icons or designs. In the described embodiment, the names are always displayed on a life portal regardless of which life page is displayed.

At step 306 the user provides criteria for populating a life page with content. Th user can populate life pages with content as desired without significant constraints imposed by the life portal service provider. The content can fall under any topic selected by the user, and may be a specialized or obscure topic. This approach to populating life pages with content reinforces the concept of building of a life portal from the bottom up to uniquely match the interests and priorities of each user.

As noted, one type of content is a magazine. The user selects a life page and creates a magazine on a particular topic presumably falling under the subject matter of the life page. The portal engine compiles the magazine for the user by searching for articles on the topic from the themed content on the life portal service provider content databases. A user can suggest or request that content at those sites be scraped so it is available for inclusion in a magazine. In the described embodiment, the service provider decides which sites will be examined for content to ensure that proscribed content is not accessed from the service provider's databases. The most relevant segments of the content are located at various web sites and aggregated to create a magazine. In any case, headlines of news stories and other types of text articles with hyperlinks from the various sites are combined to create the magazine. Thus, the magazine is highly tailored and unique to the user.

At step 308 the user continues to populate life pages with content by creating views. A view is content from a single web site and allows a user to see a portion of a third-party web site without leaving the user's life portal. In effect, a portion of the third-party web site is a component in the user's life portal and viewable using a meta-browser. Views and magazines are stored in portlets. In the case of views, portlets allow users to see views via a meta-browser, a browser nested within the user's browser used to see content from another web site. In the described embodiment, other types of content or tools, such as video or javascript, can be contained in a portlet.

Once the user creates magazines and/or views for a life page, the process of initially populating a life page with content is complete. The process is then repeated for other life pages at step 310. The user can also create a persistence panel which is always displayed in the life portal regardless of which life page is displayed. The persistence panel can be also be created configuring the life pages.

One of the goals of the present invention is to create a life portal using views and magazines stored in life pages that closely reflect the unique personality, interests, preferences, and so on of a particular user. As such, the life pages, views, and magazines of individual life portals can vary widely. The life portal service provider may also allow the user to modify, to some degree, the look and feel of the life portal. One aspect of a life portal is that it allows a user to see numerous views and magazines from different life pages simultaneously.

In the described embodiment, a user creates life pages as described at step 304 of FIG. 3. A life page can be described as a folder for views and magazines which, from the user's perspective, share a common subject or topic. A life page is given a title by the user, which may be any name desired by the user, a feature that further emphasizes the concept of the life portal reflecting the user's personality, life, and interests. Once a user has created a life page, for example, a “MOVIES” life page, the next step is to create views and magazines within MOVIES. A life page is essentially a container or folder with a user-selected name and, therefore, has no significance or use if not populated with content. In the described embodiment, content is either a view or a magazine.

Views and magazines are created on topics selected by the user. In the MOVIES life page, the user can create a view that is content from the “Hollywood Reporter” web site, another view that is content from the “Variety” web site, and so on. The user can also create a magazine that contains headlines and links to articles on movies by a particular studio. The articles and text-based content will come from various web sites, thus, a magazine is the appropriate medium for this content.

The user can assign any name to a life page, as well as to views and magazines. A life page can also be pre-created by the service provider and contain pre-created views or magazines. Pre-created life pages, views and magazines are components that the life portal service provider believes may be of interest to many of the life portal users or that the service provider would like to bring to the attention of the users because the content is of particularly high quality. For example, a pre-defined life page named by the life service provider as CURRENT EVENTS may have pre-defined views such as a segment of the CNN web site or a view showing the front page of the Wall Street Journal. Similarly, a life page can have pre-created magazines. A user can decide to keep or delete a pre-defined view or magazine in a life page and add her own views and magazines. A user can also change the name of the life page from CURRENT EVENTS to another name.

In the described embodiment, the user can perform certain functions or actions on views, magazines and life pages. For example, a user can add or delete a view, magazine, or life page. A user can also edit a view, magazine, and life page. Some of the editing functions for a life page include the following: clean-up, save, delete, refresh, and rename. Some of the editing functions for a view include: fix, move, delete, refresh, rename, and set auto refresh rate.

If a web page from which content originates undergoes a change in format or configuration, such as the insertion of a table, the user can execute a fix view operation. When a fix view operation is selected, a new window appears and the user can adjust the view as needed. For example, the user can select a different table or segment from the page or can instruct the engine to use the seventh table instead of the sixth table in a page, and so on. By performing this operation, the life portal engine will adjust how and from where it will retrieve data from the web sites. For example, a table on a web page may have been moved, re-sized, or changed in some manner. Many popular sites reconfigure the layout of their pages often.

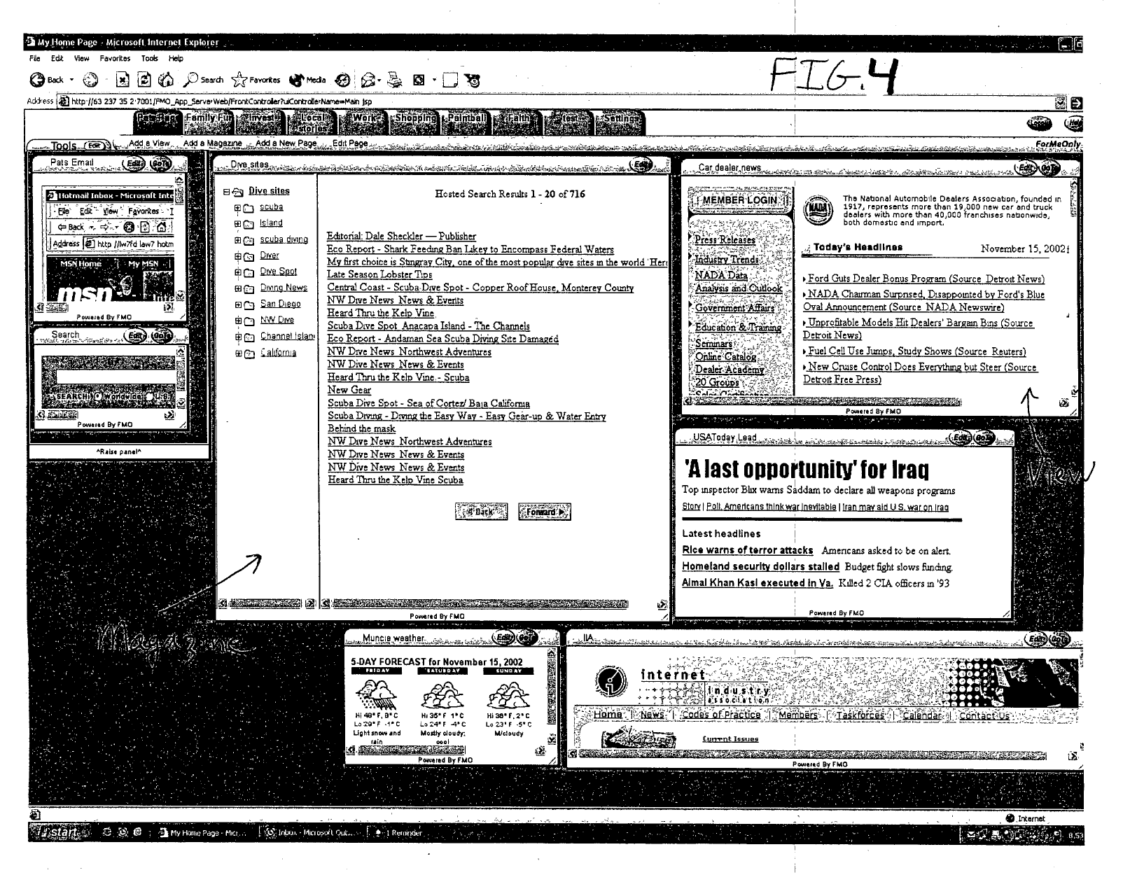

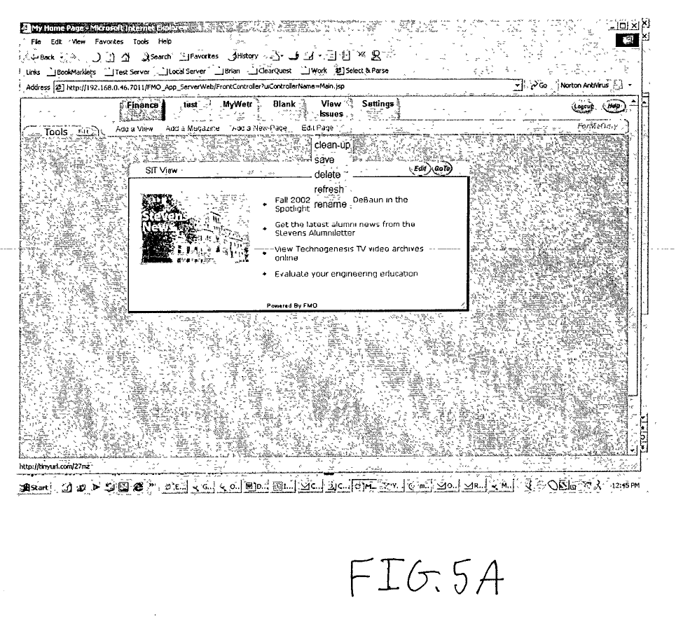

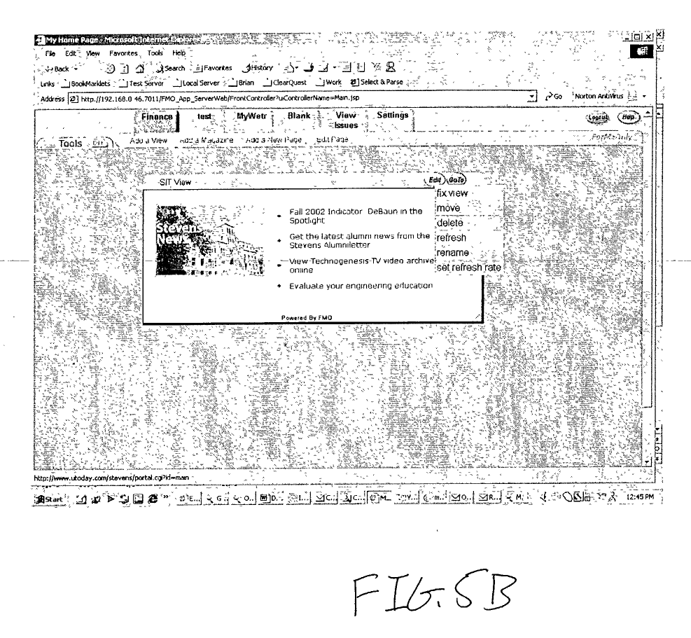

A sample magazine is shown in FIG. 4 in accordance with one embodiment of the present invention. Magazine 402 is list of headlines and links to corresponding articles stored at the life portal service provider servers and originally scraped from third-party web sites. The articles and content for a magazine are compiled from content scraped from web sites by the service provider. The various content are aggregated to form the text of the magazine articles.

Similarly, views are also unique to the user. A view, in contrast to a magazine, is from a single web site and shows content from only a selected web site. However, the user dictates what will be in the view and what content of the selected web site will comprise the view. In the described embodiment, there are two types of views: parsed views and pixel views.

Generally, a parsed view is content from a single table taken from a web page from a web site. Many web sites organize their data in web pages and tables. The life portal engine parses a web page into its separate tables. Generally, a pixel view results from retrieving an entire web page from a web site and allowing the user to display any segment of the page and does not involve parsing the web page or identifying tables in a web page.

A parsed view is created from parsing a web site into tables. As is known in the field of Internet application programming, web sites often use tables to delineate and format content on a web page. Many web sites use tables in this manner. A web page is parsed to separate the tables, each table containing a portion of content of the web site. The user selects which table will comprise the view. In the described embodiment, when selecting a table, a user moves a cursor over the tables after the page has been parsed and clicks on the table she wants. As the cursor moves over the tables, delimiters around the tables change indicating that the user is in a new table.

A pixel view is the entire web page offset behind what is visible via the portlet, in other words, a pixel view masks portions of the web page the user does not want to see. In creating a pixel view, the portal engine does not parse the web page. The entire page is loaded and configured such that the only content visible in the view is content that the user wants to see regardless of the table configuration on the web page. A pixel view is selected by a user by using a cursor to define an area on the web page that the user wants to be the view. The boxed area can be drawn anywhere on the page when defining a pixel view. Once the area has been defined, the content from the web page is placed in a portlet and becomes the view.

In the described embodiment, the user can choose whether a view is parsed or pixel. In another embodiment, the underlying structure of a view is determined by the life portal service provider. The fact that there are different types of views is visually transparent to the user. However, if content from a web site is displayed as a pixel view, an entire web page is transmitted to the life portal. Consequently, pixel views may cause unintentionally large volumes of data to be transmitted to the user's computer thereby consuming significant bandwidth and likely to cause processing slowdowns on the life portal. In contrast, parsed views result from creating content, i.e., a table, selected by the user.

Tables can be nested within other tables. In the described embodiment, the user selects tables by using a pointing device to highlight the desired tables after the service provider has parsed the HTML on a web page. For example, when a table is highlighted the background and text colors may be inverted, images may be shown in the negative, and a delimiter separating the parsed tables, such as a red line, dashes and blinks. The user then clicks on the selected table and the table becomes the view.

As described above, a view can result from parsing a web page, a parsed view, into tables or from superimposing a portlet on an entire web page and displaying a portion of the page as a view, a pixel view, in which the other portions of the web are masked from view. Generally, a web page is comprised of HTML code which can come in different flavors and types. Problems and unexpected results occur when HTML content is scraped from an originating site, transmitted to another site where the content, such as a web page, is manipulated in some manner and displayed in a meta-browser. For example, at the originating site, a web page may have windows that pop up and display advertisements or may have mechanisms for displaying error messages to users which may be undesirable in a life page. In another example, a table selected from a scraped web page may reference code, such as javascript, not in the web page or in the code for the selected table. Therefore, it is often necessary to modify the HTML and other code contained in a web page so the page content can be displayed as a view in a life page or persistence panel.

The issues and problems described above are addressed in an implementation of the life portal wherein the life portal user is not required to download any applications onto the user's computer. Thus, a user can utilize the full range of functionality of a life portal of the present invention using a typical browser without having to download or install a single application from the life portal service provider or from any other entity.

In a preferred embodiment, the user's computer, or client, is provided with an applet that executes certain functions, such as parsing and rule engines (described below), that power the life portal and enables communication with the life portal server. In this embodiment, referred to as a client-side implementation, the client invokes the retrieval or scraping of web pages from third-party sources on the Internet or from the life portal servers.

In one embodiment, referred to as a server-side implementation, the life portal server is responsible for retrieving content and transmitting the modified content to the client to be displayed as views. However, neither implementation requires that the user download or install any application software onto his or her computer. Furthermore, with both client-side and server-side implementations, the user can access her life portal from any online computer. In the client-side implementation, the browser must be able to accept applets and cookies (typical default settings).

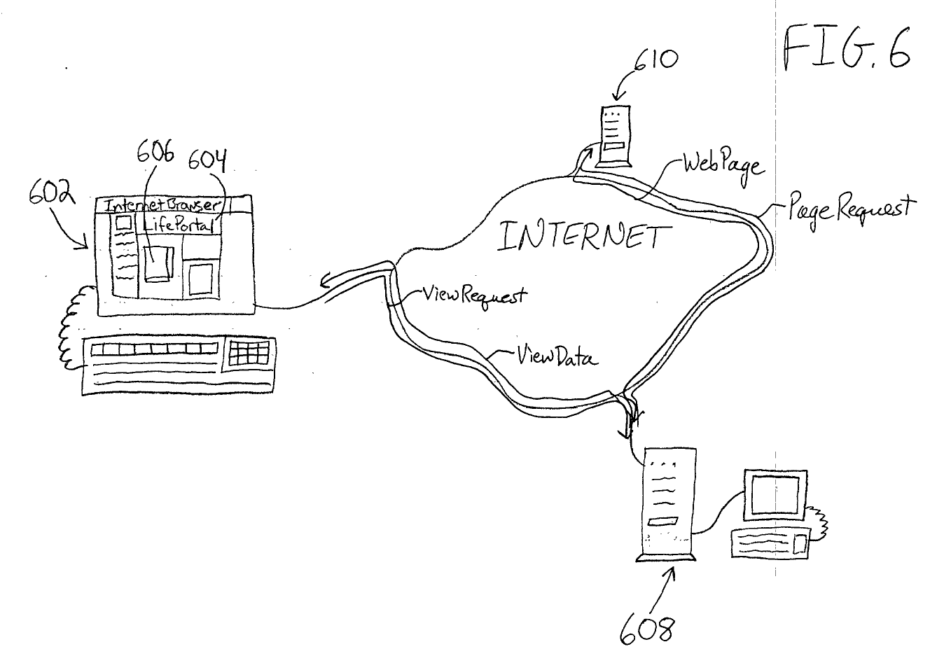

In the server-side implementation of the life portal, an online client communicates only with a life portal server and not with third-party sites. The life portal server retrieves web pages from the third-party sites, parses the HTML (for parsed views), and delivers the relevant HTML segments to the life portal on the client. FIG. 6 is a diagram showing a server-side implementation of the life portal in accordance with one embodiment of the present invention. A client computer 602 implements a life portal 604. Life portal 604 has a life page containing a parsed view 606. A parsed view is used only for illustrative purposes. The process described also applies to pixel views. Using a parsed view provides the opportunity to describe the role of a parsing engine in the overall process. When life portal 604 is invoked or opened by a user, a request for each parsed and pixel view (among other data) is transmitted from client computer 602 to a life portal server 608 over the Internet. One portion of the request to life portal server 608 is for retrieving content for view 606.

In the server-side implementation, life portal server 608 processes the request from client 602 and retrieves the content from its own database (“cached” content) or from a third-party web site 610. The content, normally a web page for each view, is retrieved and processed by life portal server 608. The processing includes parsing for parsed views. The modified HTML is transmitted to client computer 602 and displayed as view 606 in life portal 604. In this implementation, client computer 602 performs minimal processing. The speed with which client 602 accesses the modified HTML and other content from life portal server 608 depends on the type of connection, e.g., dial-up, broadband, etc., between client 602 and the Internet. In the described embodiment, life portal server 608 has high-speed connectivity with the Internet, such as broadband or a T3 connection. This is expected for acceptable performance because server 608 may retrieve content concurrently, specifically entire web pages, for numerous life portal users.

A request is an HTTP request from life portal 604 to server 608 and is associated with a view, such as view 606, and is, more specifically, from an inline frame, or iframe, representing view 606. The request contains all the parameters needed for server 608 to retrieve and process HTML content for view 606 and life portal 604. Life portal server 608 may have cached the content in its own database servers. If life portal server 608 goes to web sites to retrieve the HTML, it parses the code and extracts the table needed for parsed view 606. In the case of a pixel view, the web page is not parsed and the entire page is transmitted to life portal 604.

Although the server-side solution has advantages, for example, when the client is an Internet appliance or a so-called “thin” client, there are aspects in its operation that may be drawbacks under certain circumstances. For example, some high-traffic sites are sensitive to having the same IP address accessing it too frequently. Too many hits may slow down or bring down a web server and is a legitimate concern for many popular web sites. When performance issues arise, the third-party web server may simply deny further access to the particular IP address.

Another issue that arises in the server-side implementation is universal user authentication. Certain sites require user authentication to access content. Once a visitor is authenticated, typically by entering a username and password, the site stores a cookie on client computer 602. This allows the user to leave the site and not have to log back in if the user returns to the site within a pre-defined time frame, such as an hour, referred to as the expiration time for the cookie. However, storing cookies for users on life portal server 608 is burdensome and raises security issues with respect to the users' login names and passwords. Another issue that may arise from the server-side implementation is a third-party site suspecting that the life portal site is scraping its content and that it is consequently attracting more users and becoming more well known. The third-party site may disfavor the life portal site because the life portal service provider is accessing the content, effectively redisplaying it, and is likely not displaying the advertisements that the original site relies on for revenue.

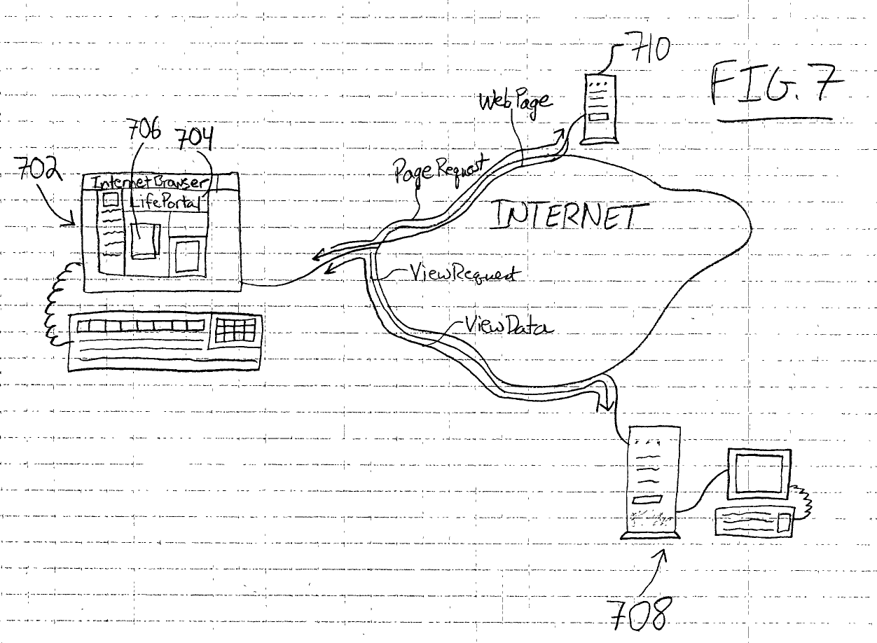

These operational limitations are addressed in a client-side implementation of the life portal shown in FIG. 7. In a preferred embodiment of the life portal implementation, a client computer 702 plays a larger role in retrieving and processing HTML for a life portal 704. Life portal 704 still makes a request for each view to a life portal server 708 similar to the request made in the server-side implementation. However, server 708 returns only data that client computer 702 needs to retrieve the content directly from the third-party sites. Life portal 704 uses these parameters relating to the view to retrieve the entire web page from a content source 710. In some cases, the web page may be cached internally at the browser on client computer 702. These parameters include data on displaying the view and retrieving the content, such as the URL for the content, rules for parsing (described below), and other data associated with the view.

Client computer 702 processes a web page using an applet it obtained when the user initially created life portal 704. The Java applet is embedded in the browser on client 702 during the initial life portal creation process. The applet is downloaded without significant intervention from the user. Typically, the user follows the routine step of “signing” the applet by clicking a button saying the user accepts it. The user simply follows the instructions for creating a life portal and in the process downloads the applet and other components needed for the portal. Downloading applets during an installation of any type of application or tool over the Internet is commonplace and generally transparent to the user. In the server-side implementation, the user follows the same steps for creating a life portal except the applet is not be embedded in the browser. However, the applet can still be imported in the server-side implementation for future use (e.g., if the user decides to switch to a client-side implementation) and be done transparently to the user.

It is possible that the user disabled the browser from accepting applets in which case the life portal can be implemented using the server-side implementation. An applet on client 702 runs a parsing engine, a rules engine, and other functions on the HTML. The functions that run on client 702 in the client-side implementation generally also run on life portal server 608 in the server-side implementation.

In the client-side implementation of the life portal, client 702 is responsible for scraping third-party sites for web pages associated with its views. In this implementation, for third-party web sites that require authentication and use cookies for re-entry to that site, a cookie from the site is stored on client 702 thereby allowing universal authentication of the user for that site. By having the cookie on client 702, life portal server 708 does not have to store the cookie or any other secure data relating to the user. In the client-side implementation, client 702 makes the request for HTML at third-party sites. Thus, high-traffic sites will not see the same IP address, i.e., the IP address of server 708, scraping content from them at all.

An applet is needed on client 702 to process the HTML on the web page because browser security restrictions do not allow web developers to edit and manipulate content at their sites using client-side script. For example, a browser can use javascripts to access HTML at a third-party site, but not modify it. The applet enables the browser on client 702 to retrieve, process, and parse, if necessary, the HTML so it may be displayed as a view. A web page request is made through a Java component in the applet using standard techniques known in the field of Internet application programming. In a preferred embodiment, the service provider determine the appropriate applet for client 702 based on the version of the Java Virtual Machine that resides on the client, e.g., the Microsoft JVM or the Sun JVM, and send the appropriate applet to the client which the applet needs in order to run Java classes. As a result, the user does not need to download any applications to upgrade or modify the applet so it is compatible with a particular JVM.

As mentioned, technical issues may arise when displaying a view in a life page scraped from a third-party web site. Content, primarily HTML code, has dependencies and functions that are susceptible to breakdowns and unpredictable behavior when separated from its original context in a web page or similar larger context. To prevent breakdowns and performance interruptions when displaying a single view or multiple views in a life page, the life portal applies a set of rules to the web content before it is displayed.

In a preferred embodiment, rules are applied to a web page according to a domain/rule set mapping table. In the client-side implementation these rules are applied by the applet. The domain/rule set mapping table is derived from two sources: a list of known domains and a set of rules. The list of known domains contains the names of web sites from which the life portal service provider scrapes content or, more broadly, for which it wants to establish rules. Typically, these will be domains from which content is scraped regularly or frequently. The list will expand to include sites requested by life portal users and from which content has been retrieved (either by the client or the life portal servers), and for which a rule mapping has been derived.

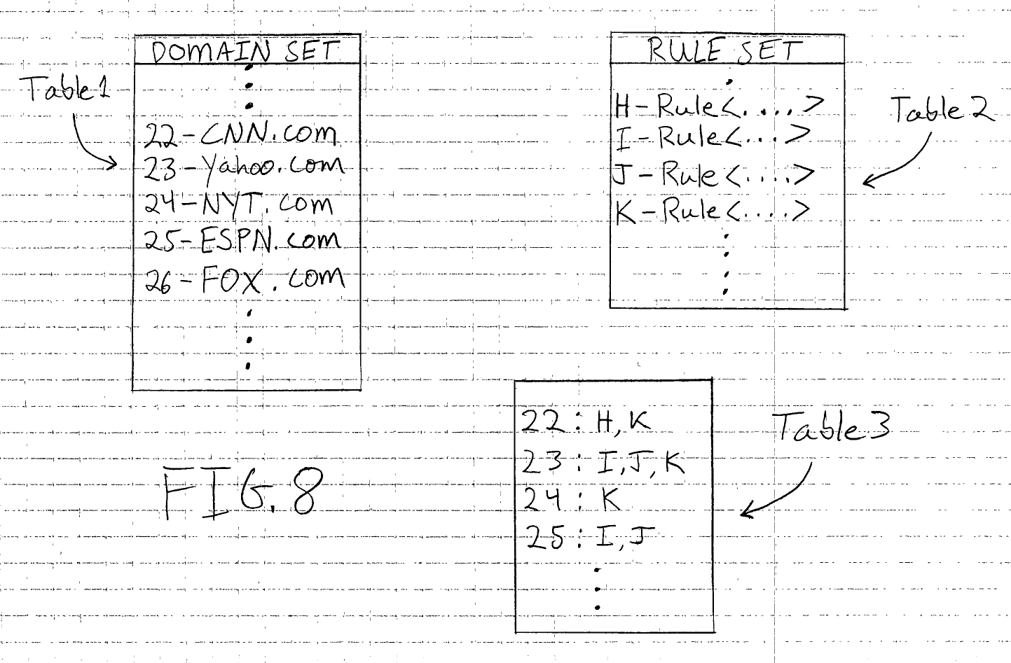

FIG. 8 is a diagram showing a logical representation of sample data sets or tables that may be used to apply rules to content before the content is displayed in a life page in accordance with one embodiment of the present invention. The tables shown in FIG. 8 are illustrative of the concepts and data constructs behind the application of rules to content. The actual implementation and programming of these logical constructs may take on various forms and can be done by a person of ordinary skill in the field of computer programming. A list of known domains is shown as Table 1. Each domain has a corresponding unique identifier. Table 2 is listing of rules or parameters that a rules engine embedded in an applet or portal engine applies to prevent unwanted behavior or breakdowns when editing content and displaying as a view. Examples of these rules are provided below. Associated with each rule in Table 2 is a unique identifier, preferably having a different format from the unique identifier used to identify the domain names in Table 1. For example, the identifiers may be alphanumeric or use only characters, as in the example shown in Table 2.

Each rule addresses one issue or problem that may arise when displaying content as a view in a life page. A majority of the problems that typically arise stem from javascript code in the web page, but may arise from other types of code. Initially, the life portal service provider anticipates many of the problems that may occur and has derived a rule or set of rules to address each problem. It is expected that unanticipated problems will arise when dealing with new sites or with new types of content. When this occurs, the service provider derives a solution to the issue and incorporates it as a rule in Table 2. Thus, Tables 1 and 2 are not static listings but rather listings that are expected to grow as the number of life portal users increases and the types of content in a web page diversifies.

Using Tables 1 and 2 and the life portal service provider's knowledge of which rules should be applied to each known domain, the service provider creates a mapping of domain names to rules. The service provider can also anticipate or detect problems that may occur beforehand and derive rules to address such problems. However, it is possible that applying one rule to a web page from a particular domain will work as expected but applying the same rule to a page from another domain will produce unwanted results. By applying a rule across pages from all listed domains, certain pages may be fixed but others may be damaged or not effected. Therefore, it is important that the service provider keep track of which rules to apply to each domain. Table 3 is an illustration of a domain name/rules mapping table that accomplishes this task. The life portal service provider determines which rule or rules, if any, need to be applied to each web site from which the service provider will be scraping content.

For example, a breakdown may occur when a portion of HTML representing a view (“view HTML”) is parsed from a web page containing javascript. The web page has HTML, however, only a portion of it, such as a table, is needed for the view. The portion needed may have HTML that is dependent on HTML or javascript that is not resident in the view HTML. As a result, when the view HTML executes on the life portal, the user sees an error message resulting from the invocation of code that does not exist in the view HTML. A rule or parameter to address this issue may be to modify the tags in the view HTML so that the error message does not appear and the user can continue operation uninterrupted. Another possible rule may be to include the dependent HTML or javascript with the view HTML. The rule or rules are selected by the life portal service provider, inserted in Table 2 and associated with one or more domains. This association is inserted in Table 3.

When a web page from a new domain is scraped, whether by the client or life portal server, a parsing engine scans the entire page and determines which of the existing rules need to be applied to the page and applies the relevant rules to the page. If the service provider determines that existing rules will not address problems arising from the view HTML, the service provider derives additional rules and adds them to Table 2.

In a preferred embodiment, rules are invoked by a rules engine in the client applet that associates domains to rules as shown in Table 3. In this embodiment, only rules that need to be applied to a page will be applied. Before rules are applied to a page, the rules engine determines the domain of the web page. For example, the engine detects that the web page is from CNN.com, checks the domain/rules table, and determines which rules should be applied to the CNN.com domain identifier. The rules are retrieved and applied to the page, thereby potentially modifying the web page in some manner. The parsing engine then parses the page. When the engine detects that a subsequent web page is from another domain, a different set of rules will be applied, although the rule(s) may happen to be the same as for the CNN.com domain.

It is expected that most web pages will need some modification so that the extracted view HTML will function smoothly as a view in a life page. For this reason, the identification and application of the rules and parameters to the web pages is necessary to minimize disruptions and unexpected behavior when utilizing views in a life portal. Furthermore, it is the a priori application of the appropriate rules to known domains—the seamless modification to the HTML and other code before displaying a view in a life page—that enables efficient and facile use of a life portal.

As web pages are scraped, the domain/rules mapping table is consulted to see which rules will be applied. As the life portal service provider adds new domains, it examines the web pages from the domain and determines which existing rules or whether any new rules are needed to address potential breakdowns or problems in displaying the view HTML from the new page. It is expected that the rules and the domain listing will grow with time and as the life portal gets more users. It is also possible that life portal users may request web pages from domains not listed in Table 1. In the described embodiment, there is a default set of rules that is applied to new domains when a customized rule set has not yet been derived. The default rule set is determined empirically, that is, from the service provider's experience with addressing issues with various types of HTML, javascript, and other code. It is expected that the default rule set will address most problems, but not all of them. This is particularly true as web sites get more sophisticated and less conventional. When problems persist after the default rule set has been applied, the service provider examines the HTML and devises new rules to address the remaining problems.

It is possible that applying a rule to a web page may have an undesired effect on the functionality of the page and, specifically, the view HTML. To illustrate, it can be assumed that life portal users do not want “pop-up” advertisements from appearing in their views. To meet this expectation, there may be a rule in Table 2 that prevents advertisement pop-ups from appearing in a life page. The HTML in the web page causes the pop-up messages appear. More specifically, it is likely that a standard javascript function or method in the web page is invoking the pop-up window and it is this method that the rule operates to suppress. This is done by overriding the standard javascript “open” method which exists by default in a browser. Therefore, instead of invoking a browser to open a pop-up window, the javascript is diverted to a method that does nothing. In this example, the life portal service provider adds a dummy or non-functioning method to the javascript. If there is an “open” method in the javascript, the new method is called; if there is no “open” method, the new method is not called.

However, if another web page from a different domain has a button or other icon in the view which when activated shows the user text in a pop-up window, wherein the text may be useful or critical information to the user. By applying the rule described above to this web page, the execution of all pop-up windows, regardless of the content, will be suppressed. By applying the rule, the button in the view will not function thereby undermining the utility of the view. By using a rules engine that implements Tables 1, 2, and 3, it is possible to selectively apply the rule to the first web page where pop-ups are used for advertisements, but not to the second web page which has buttons that show informational pop-up windows.

When creating a parsed view, the parsing engine retrieves all of the HTML from a page and parses out any style sheet references, javascript references, and the specific HTML that the user wants to see (in many cases embedded in a table, but not necessarily) and returns these components to the portlet. If no rules are applied to the web page, there may be times when javascript in the view references HTML elements that previously existed in the page, but were removed during the parsing process. If the javascript were to execute, an error would occur. Because this error results only from having modified the HTML content of the original page, the user would not be expecting it. Thus, it is important that the life portal suppress this error message. This is done by applying a rule that suppresses all javascript errors. This example explains one scenario where a javascript error would occur; there are other scenarios where javascript errors occur as well, and this rule would suppress those errors regardless of the scenario causing the error.

In the described embodiment, the Internet is used as the primary medium in which content and other data is transmitted and web sites as the primary content sources from which content is scraped and viewed on a life portal. It should be apparent that in other preferred embodiments of the invention, the content sources and medium are not limited to web sites and the Internet. Other forms of electronic data distribution could be used to gather information; information could be gathered from a variety of electronic sources other than web sites; and can be processed and displayed on via user interface and viewing tools other than Internet browsers (e.g., displays on hand held devices, smart devices, and the like). These preferred embodiments all fall within the scope of the present invention.

Although the foregoing invention has been described in some detail for purposes of clarity of understanding, it will be apparent that certain changes and modifications may be practiced within the scope of the appended claims. Furthermore, it should be noted that there are alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What we claim is:

1. A method of modifying content from a web page at a first web site for display in a life portal at a second web site, the method comprising:
determining whether the first web site is listed in a domain table;
if the first web site is listed in the domain table, identifying a rules set in a domain/rules map table, wherein the rules set corresponds to the first web site;
applying the rule set to the content, thereby making the content suitable for display in the life portal at the second web site.

2. A method as recited in claim 1 further comprising applying a default rule set to the content if the first web site is not listed in the domain table.

3. A method as recited in claim 2 further comprising creating a mapping between the first web and a rules set, wherein the rules set is stored in rules table.

4. A method as recited in claim 3 further comprising adding new rules to the rules table when the default rule set fail to adequately modify the content for display in the second web site.
